(19) United States
(12) Patent Application Publication
(10) Pub. No.: US 2026/0119613 A1
(43) Pub. Date: Apr. 30, 2026

(54) ORIGINALITY EVALUATION OF CONTENT CREATED USING INFORMATION HANDLING SYSTEMS

(71) Applicant: Dell Products L.P., Round Rock, TX (US)

(72) Inventors: Marcus Daniel Molner, Austin, TX (US); Walter Kemp, Georgetown, TX (US); Kai Wang, Shanghai (CN)

(73) Assignee: Dell Products L.P., Round Rock, TX (US)

(21) Appl. No.: 18/931,376

(22) Filed: Oct. 30, 2024

(51) Int. Cl. G06Q 10/0631

(52) U.S. Cl. CPC G06F 18/254

(57) ABSTRACT

Systems and methods provide evaluation of the originality of content created by an Information Handling System (IHS). A target response is selected from a set of responses to a task, such as a writing assignment, where the target response is presented by an author. A first library is generated from automated responses to the task. A second library is generated from the set of responses to the task, except for the target response of the author. An originality rating is generated for the target response based on inputs to an originality evaluation model include inputting the target response to a designated target input node of the model and also include inputting the first and second libraries to respective library input nodes of the model, where outputs by the model include the originality rating.

### FIELD

This disclosure relates generally to Information Handling Systems (IHSs), and more specifically, to evaluating the originality of content created using IHSs.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. Variations in IHSs allow for IHSs to be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

Personal IHSs, such as a laptop or desktop computer, are used in a wide array of different forms of content creation. For instance, users of an IHS may operate software programs on the IHS to draft documents and create images. Recently, artificial intelligence (AI) tools available via the Internet have allowed users to generate high-quality writings and images based on prompts and other information provided to the AI tools. With the proliferation and emerging sophistication of such AI tools, discerning whether content has been generated in whole or in part by such AI tools is increasingly difficult.

### SUMMARY

In various embodiments, systems and methods provide evaluation of the originality of content created by an Information Handling System (IHS). Embodiments may include: selecting a target response from a set of responses to a task, wherein the target response to the task is presented by an author; generating a first library of automated responses to the task; generating a second library comprising the set of responses to the task, except for the target response of the author; and generating an originality rating for the target response based on inputs to an originality evaluation model comprising inputting the target response to a designated target input node of the model and inputting the first and second libraries to respective library input nodes of the model, wherein outputs by the model comprise the originality rating.

Some embodiments may include generating a third library of additional works by the author, wherein the original rating for the target response is further based on inputting the third library additional works to a designated input node of the model. Some embodiments may include generating a ranked list of responses, wherein the response are ranked based on similarly to the target response, and wherein outputs by the model further comprise the ranked list of response. In some embodiments, the responses that are candidates for inclusion in the ranked list of responses are selected from the inputs to the first library and second library that are input to the originality evaluation model. Some embodiments may include generating a set of attributes characterizing stylistic attributes for each of the responses to the task. Some embodiments may include aggregating the set of attributes generated though characterizing stylistic attributes of the AI responses, wherein the aggregated attributes of the AI responses are input to a designated input node of the originality evaluation model and used in generating the originality rating. In some embodiments, attributes generated though characterizing stylistic attributes of the target response are input to a designated input node of the originality evaluation model and used in generating the originality rating. Some embodiments may include aggregating the set of attributes generated though characterizing stylistic attributes of response from the second library, wherein the aggregated attributes of the responses in the second library are input to a designated input node of the originality evaluation model and used in generating the originality rating. In some embodiments, the originality evaluation model comprises a neural network, wherein the target response and the first library and the second library are inputs to the neural network, and wherein the originality rating is an output of the neural network.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram illustrating examples of components of an Information Handling System (IHS) configured, according to some embodiments, for evaluation of the originality of content created using the IHS.

FIG. 2 is a flowchart illustrating an example of a method, according to some embodiments, for evaluation of the originality of content created using an IHS.

FIG. 3 is a diagram illustrating certain aspects of a originality scoring AI model, according to some embodiments, for evaluation of the originality of content created using an IHS.

### DETAILED DESCRIPTION

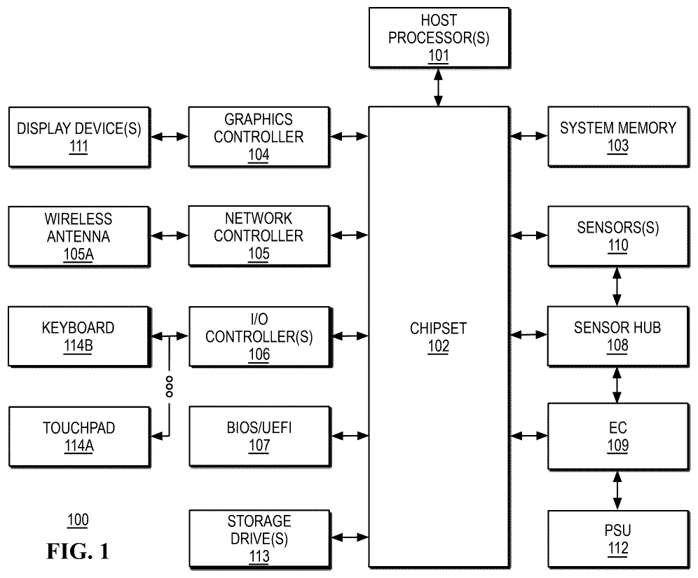

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An example of an IHS is described in more detail with regard to FIG. 1.

FIG. 1 is a diagram illustrating examples of components of an Information Handling System (IHS) 100 configured, according to some embodiments, to support evaluation of the originality of content created using other IHSs. In some embodiments, IHS 100 may be a laptop computer or a desktop computer that may operate various software applications by which the user of the IHS may generate various forms of content. For instance, a user of IHS 100 may utilize a text editing application to generate a document and may use a graphics application to generate an image, where various combinations of text and image generation may also be supported by an application.

As described, the use of AI tools has allowed a user of an IHS to create works, such as text and images, that are comparable in quality to human-generated content. Users can invoke such AI tools to create content and may take credit for generating the content generated by the AI tool. Accordingly, in embodiments, an IHS 100 may be configured to detect possible uses of such AI tools and/or other forms of plagiarism. For instance, IHS 100 may be used to evaluate a set of writings that have been submitted as responses to a scholarly assignment, or as part of an application process. Accordingly, in embodiments, an IHS 100 supports an originality evaluation tool that provides evaluations of the originality of responses to a specified task, such as a set of written responses to a provided problem statement. Embodiments may rely on one or more remote systems to support a originality evaluation AI model, such as described in additional detail below. In some embodiments, a local originality evaluation tool may operate as operating system function of the IHS, and may be useable within one or more of the user applications that are supported by the operating system.

As illustrated, IHS 100 includes host processor(s) 101. In various embodiments, IHS 100 may be a single-processor system, a multi-processor system including two or more processors and/or processor cores. Host processor(s) 101 may include any processor capable of executing program instructions, such as a PENTIUM processor, or any general-purpose or embedded processor implementing any of a variety of Instruction Set Architectures (ISAs), such as an x86 or a Reduced Instruction Set Computer (RISC) ISA (e.g., POWERPC, ARM, SPARC, MIPS, etc.). IHS 100 utilizes a chipset 102 that may include one or more integrated circuits that are connected to processor 101. In the embodiment of FIG. 1, processor 101 is depicted as separate component from chipset 102. In other embodiments, all of chipset 102, or portions of chipset 102 may be implemented directly within the integrated circuitry of the processor 101. Chipset 102 provides the processor(s) 101 with access to a variety of resources of the IHS.

In some embodiments, processor 101 may include an integrated memory controller that may be implemented directly within the circuitry of the processor 101, or the memory controller may be a separate integrated circuit that is located on the same die as the processor 101. The memory controller may be configured to manage the transfer of data to and from the system memory 103 of the IHS 100 via a high-speed memory interface. The system memory 103 provides the processor 101 with a high-speed memory that may be used in the execution of computer program instructions by the processor 101. Accordingly, system memory 103 may include memory components, such as such as static RAM (SRAM), dynamic RAM (DRAM), NAND Flash memory, suitable for supporting high-speed memory operations by the processor 101. In certain embodiments, system memory 103 may combine both persistent, non-volatile memory and volatile memory. In certain embodiments, the system memory 103 may be comprised of multiple removable memory modules.

As illustrated, a variety of resources may be coupled to the processor(s) 101 of the IHS 100 through the chipset 102. For instance, chipset 102 may be coupled to a wireless network controller 105 that may support different types of wireless network connectivity. In certain embodiments, wireless network controller 105 may include one or more Network Interface Controllers (NICs). In some embodiments, wireless network controller 105 may implement hardware for communicating via a specific networking technology, such as Wi-Fi, BLUETOOTH, and mobile cellular networks (e.g., CDMA, TDMA, LTE). In some embodiments, network controller 105 may support wireless Wi-Fi communications, and my include a Wi-Fi controller or wireless NIC card by which IHS 100 transmits and receives wireless Wi-Fi signals.

In some embodiments, the wireless signaling utilized by wireless network controller 105 may be implemented using multiple wireless antenna 105a. In transmitting and receiving wireless signals using multiple antenna 105a, the strength of signals that are received by each of these antenna 105a may be analyzed to provide directional information regarding the environment in which the wireless signals are propagated. In some embodiments, the directional information that is used in the transmission and reception of wireless signals from each of the antenna 105a may be used to detect the presence of the user of the IHS 100 relative to the position of the IHS itself.

Returning to the hardware and software of an IHS according to embodiments, chipset 102 also provides processor 101 with access to one or more storage drives 113. In various embodiments, storage drives 113 may be integral to the IHS, or may be external to the IHS 100. In some embodiments, storage drive(s) 113 may be accessed via a storage controller that may be an integrated component of the storage device. In some embodiments, a storage controller may be a system-on-chip function of processor(s) 101. Storage drive(s) 113 may be implemented using any memory technology allowing IHS 100 to store and retrieve data. For instance, storage drive(s) 113 may be a magnetic hard disk storage drive or a solid-state storage drive. In certain embodiments, storage drive(s) 113 may include a system of storage devices, such as a cloud drive accessible via network interface 105.

As illustrated, IHS 100 also includes a BIOS (Basic Input/Output System) 107 that may be stored in a non-volatile memory accessible by chipset 102. In some embodiments, BIOS 107 may be implemented using a dedicated microcontroller coupled to the motherboard of IHS 100. In some embodiments, BIOS 107 may be implemented as operations of embedded controller 109. Upon powering or restarting IHS 100, processor(s) 101 may utilize BIOS 107 instructions to initialize and test hardware components coupled to the IHS 100. The BIOS 107 instructions may also load an operating system for use by the IHS 100. The BIOS 107 provides an abstraction layer that allows the operating system to interface with certain hardware components of the IHS 100. The Unified Extensible Firmware Interface (UEFI) was designed as a successor to BIOS. As a result, many IHSs utilize UEFI in addition to or instead of a BIOS. As used herein, BIOS is intended to also encompass UEFI.

As described, one or more display devices 111 may be coupled to IHS 100. Display device(s) 111 may include a plurality of pixels that are arranged in a matrix and are configured to display visual information. Display device(s) 111 may include Liquid Crystal Display (LCD), Light Emitting Diode (LED), organic LED (OLED), or other thin film display technologies. IHS 100 may support an integrated display device, such as a display integrated into a laptop, tablet, 2-in-1 convertible device, or mobile device. In some embodiments, IHS 100 may be a hybrid laptop computer that includes dual integrated displays incorporated in both of the laptop panels. IHS 100 may also support use of one or more external displays, such as external monitors that may be coupled to IHS 100 via various types of couplings. External displays that are supported by IHS 100 may also include a projection display. The external displays of an IHS 100 may also include wearable displays, such as displays integrated within VR headsets.

In some embodiments, one or more of the display devices 111 may be capable of receiving touch inputs from a user. In some embodiments, these touch inputs received via display devices 111 may be processed by a touch controller that may be separate from other controllers used the display of content. In some embodiments, the touch controller functions may be implemented by a display controller. In some embodiments, touch controller may be an embedded component of an individual display device 111, such that IHS 100 may support multiple distinct touch controllers, each processing inputs from a separate display device 111, such as integrated touch controllers processing inputs from separate display panels of a laptop IHS.

In some embodiments, chipset 102 may operate the one or more display device(s) 111 via a graphics processor and/or GPU (Graphics Processor Unit) 104. In certain embodiments, a graphics processor 104 may be comprised within a video or graphics card or within an embedded controller installed within IHS 100. In certain embodiments, a graphics processor 104 may be integrated within processor 101, such as a component of a system-on-chip. In some embodiments, the content filtering described herein may interoperate with graphics processor 104 in the redacting images and video, such as through replacing specific images or frames of video with blank or color-coded content.

Chipset 102 may also provide access to one or more user input devices, in some instances using one or more I/O controller(s) 106 or the like. Examples of user input devices include, but are not limited to a touchpad (such as a touchpad integrated in the palm rest area of a laptop IHS), keyboard 114B and mouse 114C. In some embodiments, a single controller may support multiple of these user input devices, such as a keyboard controller that detects inputs from the keyboard 114B and also detects inputs from a touchpad 114 integrated in the palm rest, and also detects mouse 114C inputs detected by buttons included on or under a palm rest of an laptop IHS 100. In some embodiments, other user input devices supported through the operation of I/O controller(s) 106 may include a stylus, microphone(s) and camera(s) that may each be integrated or external components of an IHS 100.

Some IHS 100 embodiments may utilize an embedded controller 109 that may be a motherboard component of IHS 100 and may include one or more logic units. In certain embodiments, embedded controller 109 may operate from a separate power plane from the main processors 101 of IHS, and thus from the operating system functions of IHS 100. In some embodiments, firmware instructions utilized by embedded controller 109 may be used to operate a secure execution environment that may include operations for providing various core functions of IHS 100, such as power management and management of certain operating modes of IHS.

For instance, embedded controller 109 may implement operations for interfacing with a power supply unit (PSU) 112 in managing power for IHS 100. In certain instances, the operations of embedded controller may determine the power status of IHS 100, such as whether IHS 100 is operating strictly from battery power, whether any charging inputs are being received by power supply unit 112, and/or the appropriate mode for charging the one or more battery cells of the IHS using the available charging inputs. Embedded controller 109 may support routing and use of power inputs received via a USB port and/or via a power port supported by the power supply unit 112. In addition, operations of embedded controller 109 may interoperate with power supply unit 112 in order to provide battery status information, such as the state of charge of the battery.

In some embodiments, embedded controller 109 may also implement operations for detecting certain changes to the physical configuration of IHS 100 and managing the modes corresponding to different physical configurations of IHS 100. For instance, where IHS 100 is a laptop computer or a convertible laptop computer, embedded controller 109 may receive inputs from a lid position sensor that may detect whether the two sides of the laptop have been latched together, such that the IHS is in a closed position. In response to lid position sensor detecting latching of the lid of IHS 100, embedded controller 109 may initiate operations for shutting down IHS 100 or placing IHS in a low-power mode. In this manner, IHS 100 may support the use of various power modes. In managing the operation of IHS 100 according to its physical posture, embedded controller 109 may identify any number of IHS physical postures, including, but not limited to: laptop, stand, tablet, or book postures. IHS 100 may include a wide variety of sensors 110 for use in gathering telemetry data that can be used in the management of operations by the IHS, and in embodiments, for describing the context of the IHS's 100 current operations.

In some embodiments, an IHS 100 may not include all of the components shown in FIG. 1. In other embodiments, an IHS 100 may include other components in addition to those that are shown in FIG. 1. Furthermore, some components that are represented as separate components in FIG. 1 may instead be integrated with other components. For example, in certain embodiments, all or a portion of the operations executed by the illustrated components may instead be provided by components integrated into processor(s) 101 as systems-on-a-chip.

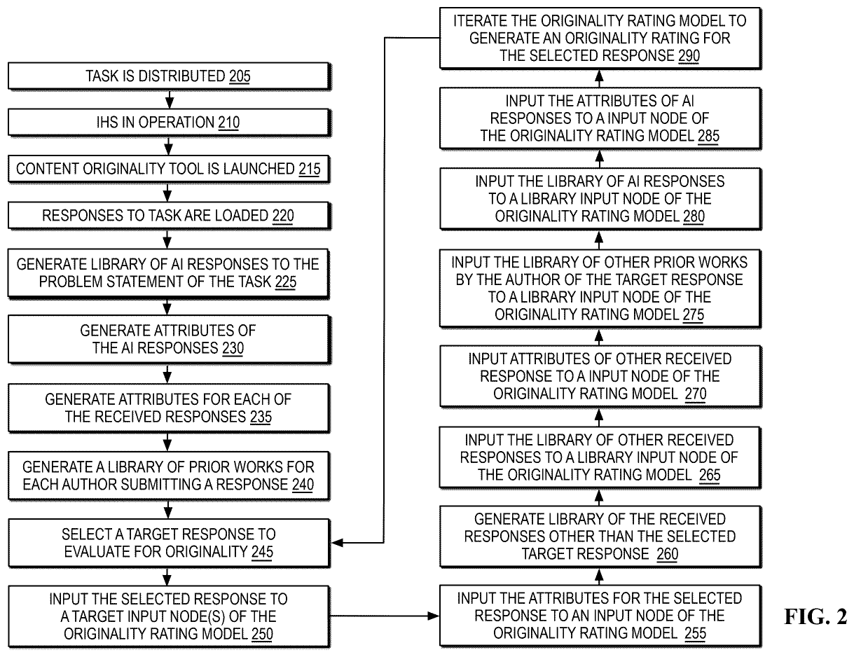

FIG. 2 is a flowchart illustrating an example of a method, according to some embodiments, for evaluation of the originality of content created using an IHS. Embodiments may begin, at 205, with the assignment and distribution of a task, where individuals will create content in response to the task. For instance, a professor or teacher may assign students a problem with a written response. An organization may distributed a job application that includes a written response. A college or other institution may ask applicants to provide a written response to a prompt. Embodiments may include a wide variety of other scenarios where a task is distributed and written responses are generated and submitted in return.

After some time, the responses are submitted by their respective authors. The assignor of the task may then be required to determine whether the responses are original works written by the author submitting the response, or whether the responses appear to be plagiarized. In embodiments, an originality evaluation tool of IHS 100 is utilized by a user that is evaluating the responses to the task for originality, and in particular identify responses that appear to borrow from works produced by AI tools, by other responders and/or other prior works by a respondent to the task.

Embodiments may the continue, at 205, with the initialization of an IHS 100, such as upon booting or restarting the IHS. In some embodiments, upon initialization of an IHS, instructions to be loaded for use by hardware components of the IHS, such as firmware and other settings, may be validated as authentic based on comparisons of the instructions to be loaded against reference signatures corresponding to authentic instructions. Upon successful validation of such instructions, one or more of the hardware components of the IHS 100 may load validated instructions and may thus operate based on execution of these trusted instructions.

Once firmware instructions have been validated, further initialization may include initiating the IHS 100 boot sequence and loading operating system instructions. Once a requisite amount of instructions have been loaded the IHS may boot an operating system and, at 210, the IHS may be operated by the user. The IHS may be operated for any amount of time by the user until, at 215, the originality evaluation tool is launched. As described, the originality evaluation tool may be an application that runs in the operating system of the IHS. In some embodiments, the originality evaluation tool may interface with any number of local and remote systems that may provide the tool with access to the received responses to the task that was distributed.

The user of the IHS may begin evaluation of these response, at 220, by identifying and loading the set of received responses. The set of responses may be a set of files stored locally on a storage drive of the IHS, or may be retrieved for evaluation from a remote storage, such as cloud storage. Once the set of responses has been identified and loaded for evaluation, at 225, embodiments may begin their evaluation by generating a set of AI responses to the task that was distributed. As described, a variety of AI tools are freely available via the Internet and these AI tools generate written works that are increasingly difficult to distinguish from human-generated writings.

Embodiments may submit the distributed task, and variations on the precise formulation of the task, to multiple different such AI tools and may request a written response that adheres to the same parameters provided to the authors that have submitted responses. For instance, an assigned prompt or problem statement may be input to these tools and a response may be requested that conforms to the assigned limits for the responses and that conforms to particular writing styles that would be appropriate for a response.

In this manner, embodiments may generate a library of different AI responses to the submitted task. Based on this library, at 230, a set of attributes are generated that characterize stylistic aspects of the individual AI responses. For instance, embodiments may calculate attributes characterizing the number and sizes of the paragraphs in each of the AI responses. Similarly, the use of formatting and associated symbols (e.g., bullet points, outlining styles) may be noted as attributes used in each of the AI responses. The generated attributes may also include characterizing the use of any footnotes and may characterize the number, size and location of the footnotes in each of the AI responses. The collected attributes may also include characterizing the use of any headers or footers in each of the AI responses.

Embodiments may generate various attributes that characterize individual paragraphs or other blocks of text in each of the AI responses. For instance, the number of words and sentences in each paragraph may be used to characterize the complexity of blocks of text. The complexity of individual sentences may be determined based on the number of words, the number of syllables in these words, and the internal punctuation that is used (e.g., commas, colons, semicolons, etc.). The attributes of individual sentences may be further characterized based on grammatical styles such as sentence structures and the use of passive versus active voice descriptions.

In some embodiments, the collected data may be used to generate additional attributes that characterize the internal consistency of the AI responses. For instance, attributes may characterize the different sizes and complexity of paragraphs that are used, and the variance in these characteristics that are typically seen within a response. In some embodiments, the attributes generated for each of the AI responses may be aggregated to generate a statistically summarized set of attributes that may be used to represent typical and atypical attributes of a response to the distributed task.

Once these attributes have been generated for the AI responses to the distributed task, at 235, these same attributes are calculated based on stylistic aspects of each of the received responses to the distributed task. As described, attributes characterizing the paragraphs, sentences and internal consistency of each of the received responses may be generated. Unlike the AI submissions, these attributes may be calculated for each response, but attributes that combine or span multiple responses are not calculated. Instead, these attributes of individual responses will may used as inputs along with the response to a originality evaluation model that will be used to calculate an originality rating for each of the received responses to the distributed tasks. However, as described in additional detail below, these attributes of the received may be aggregated, except for the attributes of a target response that is being evaluated for originality.

Accordingly, at 245, the originality evaluation tool selects a response to initiate the evaluations of originality for each of the responses for which attributes have been generated. Embodiments may utilize an originality evaluation AI model to generate an originality rating for each of the responses, where the originality rating reflects the degree to which a response is not a product of AI tools, and to which the response is distinct from the other received responses, and to which the response is distinct from other writings by the author of the response. As described in additional detail below, the originality evaluation tool may cycle through each of the responses and may calculate an originality score for each of them.

Once an originality score has been generated for each response, in some embodiments, the originality evaluation tool may rank the responses according to their originality. In some embodiments, the originality evaluation tool may identify the most original responses and/or the least original responses that may be a product of plagiarism. In addition to generating an originality score for each response, in some embodiments, for each response, the originality evaluation AI model may generate a ranked list of most similar AI responses, and/or most similar responses by others, and/or most similar prior works by the author of the target response.

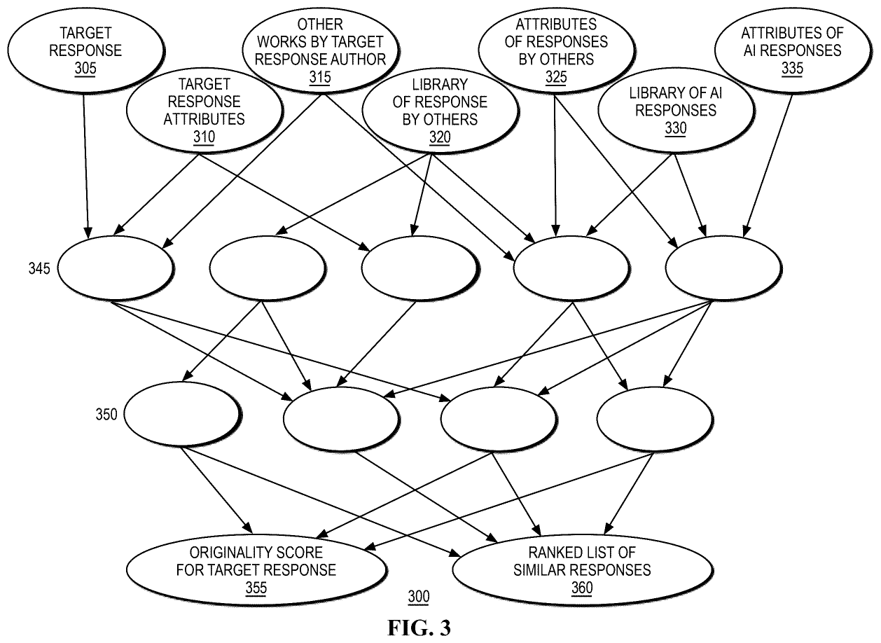

FIG. 3 is a diagram illustrating certain aspects of an originality evaluation AI model 300, according to some embodiments, for evaluation of the originality of content created using an IHS. In some embodiments, the originality evaluation model 300 may be a neural network that receives inputs for use in generating an originality score for a target response. As such, the originality evaluation tool may invoke the model 300 for generating an originality score for the target response, where the originality evaluation model may operate on the IHS 100, or may be a remote service invoked by the originality evaluation tool that runs on the IHS.

In some embodiments, at 250, the originality evaluation tool begins use of the originality evaluation model 300 to generate an originality score for the target response by inputting the response itself to a designated target input node 305 of the model. In some embodiments, the input to the target response node 305 may include only the text from the target response, without any formatting or other content. As described, such formatting and various other content in the response may be used to generate attributes that characterize such stylistic aspects (i.e., separate from the content) of the target response. At 255, these generated attributes of the target response may be identified and, as indicated in FIG. 3, are input to node 310 that is designated for initial evaluation of these attributes of the target response.

With the target response and its attributes loaded for use at designated input nodes, at 260, embodiments generate a library of all of the other received responses, except for the target response for which the originality score is being generated. At 265, this library of responses that does not include the target response is provided as an input to a designated library node 320 of the originality evaluation model. Through training, embodiments of the originality evaluation model 300 may generate an output 355 originality score for the target response that is input to the designated target input node 305, and the model 300 may also generate an output 360 that lists the other responses that are most similar to the target response. As described in additional detail below, in some embodiments, the responses that are provided as inputs to input nodes designated as library nodes that may be candidates for including in a ranked list of responses that are most similar to the target response.

As described above, attributes are generated based on the AI responses to the task and are also generated based on each of the submitted responses. Similar to the library node of responses other than the target response, at 270, the attributes calculated for each of the responses, other than the target response, are input to a designated node 325 of the originality evaluation model 300. Each set of attributes characterizes stylistic aspects of an individual response. In some embodiments, the set of attributes for the responses other than the target response may be input separately input to node 325, such as via a data structure supported by the input node. In some embodiments, the set of attributes for the responses other than the target response may be aggregated, in the same manner as the AI responses above, to generate a statistically summarized set of attributes that may be used to represent typical and atypical attributes of received responses to the distributed task, not including the target response.

As indicated in FIG. 3, another input node 315 is used to receive one or more other works by the author of the target response. Accordingly, at 240, of FIG. 2, any available written works by the authors of submitted responses are identified and evaluated for use as inputs to the originality evaluation model. In some scenarios, no other works by an author of the target response will be available. However, in an educational setting, embodiments have access to prior works by the author. In scenarios where prior works are available, at 275, these other writings may be submitted to a designated library node 315 of the originality evaluation model. As library node inputs, these other writings by the author of the target response may be candidates for listing within the output 360 of similar responses to the target response, thus identifying instances where the author of the target response has submitted a close variation to a prior submission by the author.

Embodiments may continue loading of the originality evaluation model, at 280, by inputting the library of AI responses to the task to a designated input library node 330. As inputs to the originality evaluation model 300, these AI responses may be used as reference points for assessing the originality of the target response. As with the responses by others that are input to library node 320, the input node 330 of the AI responses is designated as a library node such that these AI responses may candidates for the ranked list of most similar responses to the target response.

As described, attributes may have been generated that characterize the stylistic aspects of the AI response, both individually and collectively. In some embodiments, at 285, some or all of these attributes of the AI responses may be input to a designated node 335 of the originality evaluation model. In some embodiments, the individual and collective attributes of the AI response may be inputs to node 335. In some embodiments, only the collective, aggregated attributes that characterize stylistic aspects spanning the set of AI response may be used as inputs to node 335.

With all of the inputs 305, 310, 315, 320, 325, 330, 335 to the originality evaluation model identified, at 290, the model is iterated to generate an originality score for the target response, at output node 355. At each iteration, another output 360 of the originality evaluation model may provide a ranked listing of the inputs the designated library nodes that most closely resemble the target response. As described, inputs to the AI model for AI response 330, responses other than the target response 320, and/or other works by the author of the target response 315 may be input to nodes designated as library nodes. Through training, the originality evaluation model 300 may be used to generate a ranked listing of these library node inputs, thus identifying the other writings that most closely resemble the target response.

Once the originality score and listing of similar works has been generated, at 245, embodiments may continue evaluation of another submitted response for originality evaluation. This next response becomes the target response and the prior target response is now part of the library of responses other than the target response that is input to node 320. In this manner, the other inputs nodes of the originality evaluation model may be refreshed to reflect the new target response and another iteration of the originality evaluation model is repeated to generate an originality score and to identify similar responses for another submitted response to the distributed task.

As illustrated in FIG. 3, the input nodes 305, 310, 315, 320, 325, 330, 335 may be connected to multiple intermediate layers 345, 350 of nodes. As illustrated, a variety of interconnected pathways may be present between the input layer nodes and the nodes of the intermediate layers 345, 350. However, the illustrated connections of the nodes of the originality evaluation model are illustrative. Through training of the originality evaluation model, the internal structure of intermediate layer 345, 350 nodes and connections may be modified to any supported internal configuration. Accordingly, originality evaluation model embodiments may utilize any number of intermediate layers and any number of nodes in each of these layers. The training of the originality evaluation model may also alter the internal operations of the model through modifications to weights associated with each of the node signaling pathways and/or to activation functions used by individual nodes in determining whether to fire based on received inputs, and thus to propagate outgoing signals to connected downstream nodes.

The neural network described herein may be implemented using various varieties and combinations of neural network technologies. For instance, a convolution neural network (CNN) may be utilized, where various different types of internal layers 345, 350 may be included, such as use of multiple convolution and pooling layers. As described above, stylistic aspects of responses may be characterized through a set of a attributes. As abstractions of a response, such sets of attributes may be considered analogous to a feature map abstraction that is generated through convolution layer processing of images using CNNs. Since embodiments utilize these sets of response attributes as inputs, fewer convolution layers are required, thus improving the ability to quickly train and operate the model.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). This may include selecting predefined logic blocks and logically associating them. It may also include programming computer software-based logic of a retrofit control device, wiring discrete hardware components, or a combination of thereof. Such configured devices are physically designed to perform the specified operation(s).

Various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. A method for evaluation of originality of content created by an Information Handling System (IHS), the method comprising:
selecting a target response from a set of responses to a task, wherein the target response to the task is presented by an author;
generating a first library of automated responses to the task;
generating a second library comprising the set of responses to the task, except for the target response of the author; and
generating an originality rating for the target response based on inputs to an originality evaluation model comprising inputting the target response to a designated target input node of the model and inputting the first and second libraries to respective library input nodes of the model, wherein outputs by the model comprise the originality rating.

2. The method of claim 1, further comprising generating a third library of additional works by the author, wherein the original rating for the target response is further based on inputting the third library additional works to a designated input node of the model.

3. The method of claim 1, further comprising generating a ranked list of responses, wherein the response are ranked based on similarly to the target response, and wherein outputs by the model further comprise the ranked list of response.

4. The method of claim 3, wherein the responses that are candidates for inclusion in the ranked list of responses are selected from the inputs to the first library and second library that are input to the originality evaluation model.

5. The method of claim 1, further comprising generating a set of attributes characterizing stylistic attributes for each of the responses to the task.

6. The method of claim 5, further comprising aggregating the set of attributes generated though characterizing stylistic attributes of the AI responses, wherein the aggregated attributes of the AI responses are input to a designated input node of the originality evaluation model and used in generating the originality rating.

7. The method of claim 5, wherein attributes generated though characterizing stylistic attributes of the target response are input to a designated input node of the originality evaluation model and used in generating the originality rating.

8. The method of claim 7, further comprising aggregating the set of attributes generated though characterizing stylistic attributes of response from the second library, wherein the aggregated attributes of the responses in the second library are input to a designated input node of the originality evaluation model and used in generating the originality rating.

9. The method of claim 1, wherein the originality evaluation model comprises a neural network, wherein the target response and the first library and the second library are inputs to the neural network, and wherein the originality rating is an output of the neural network.

10. An Information Handling System (IHS) comprising:
one or more processors; and
one or more memory devices coupled to the one or more processors, the memory devices storing computer-readable instructions that, upon execution by the one or more processors, cause the first IHS to:
select a target response from a set of responses to a task, wherein the target response to the task is presented by an author;
generate a first library of automated responses to the task;
generate a second library comprising the set of responses to the task, except for the target response of the author; and
generate an originality rating for the target response based on inputs to an originality evaluation model comprising inputting the target response to a designated target input node of the model and inputting the first and second libraries to respective library input nodes of the model, wherein outputs by the model comprise the originality rating.

11. The IHS of claim 10, further configured to generate a third library of additional works by the author, wherein the original rating for the target response is further based on inputting the third library additional works to a designated input node of the model.

12. The IHS of claim 10, further configured to generate a ranked list of responses, wherein the response are ranked based on similarly to the target response, and wherein outputs by the model further comprise the ranked list of response.

13. The IHS of claim 12, wherein the responses that are candidates for inclusion in the ranked list of responses are selected from the inputs to the first library and second library that are input to the originality evaluation model.

14. The IHS of claim 10, further configured to generate a set of attributes characterizing stylistic attributes for each of the responses to the task.

15. The IHS of claim 10, wherein the originality evaluation model comprises a neural network, wherein the target response and the first library and the second library are inputs to the neural network, and wherein the originality rating is an output of the neural network.

16. A computer-readable storage device having instructions stored thereon for evaluation of originality of content created by an IHS (Information Handling System), wherein execution of the instructions by one or more processors of the IHS causes the one or more processors to:
select a target response from a set of responses to a task, wherein the target response to the task is presented by an author;
generate a first library of automated responses to the task;
generate a second library comprising the set of responses to the task, except for the target response of the author; and
generate an originality rating for the target response based on inputs to an originality evaluation model comprising inputting the target response to a designated target input node of the model and inputting the first and second libraries to respective library input nodes of the model, wherein outputs by the model comprise the originality rating.

17. The storage device of claim 16, wherein execution of instructions further causes the processors to generate a third library of additional works by the author, wherein the original rating for the target response is further based on inputting the third library additional works to a designated input node of the model.

18. The storage device of claim 16, wherein execution of instructions further causes the processors to generate a ranked list of responses, wherein the response are ranked based on similarly to the target response, and wherein outputs by the model further comprise the ranked list of response.

19. The storage device of claim 18, wherein the responses that are candidates for inclusion in the ranked list of responses are selected from the inputs to the first library and second library that are input to the originality evaluation model.

20. The storage device of claim 16, wherein execution of instructions further causes the processors to generate a set of attributes characterizing stylistic attributes for each of the responses to the task.
